(19) United States
(12) Patent Application Publication
(10) Pub. No.: US 2014/0331289 A1
(43) Pub. Date: Nov. 6, 2014

(54) METHOD AND DEVICE FOR PLAYING A VIDEO AND COMPUTER-READABLE STORAGE MEDIUM

(71) Applicant: TENCENT TECHNOLOGY (SHENZHEN) COMPANY LIMITED, Shenzhen City (CN)

(72) Inventors: Wei LI, Shenzhen City (CN); Huijiao YANG, Shenzhen City (CN); Ying HUANG, Shenzhen City (CN); Bo HU, Shenzhen City (CN); Ruiyi ZHOU, Shenzhen City (CN); Xin QING, Shenzhen City (CN); Xi WANG, Shenzhen City (CN); Kai ZHANG, Shenzhen City (CN); Yulei LIU, Shenzhen City (CN); Zhipei WANG, Shenzhen City (CN)

(73) Assignee: TENCENT TECHNOLOGY (SHENZHEN) COMPANY LIMITED, Shenzhen City (CN)

(21) Appl. No.: 14/284,710

(22) Filed: May 22, 2014

Related U.S. Application Data
(63) Continuation of application No. PCT/CN2013/089267, filed on Dec. 12, 2013.

(30) Foreign Application Priority Data
Apr. 28, 2013 (CN) 201310157755.8

(51) Int. Cl. H04L 29/06

(52) U.S. Cl. CPC H04L 63/08; H04L 65/403
USPC 726/4; 709/205

(57) ABSTRACT

A method and device for playing a video are disclosed. The method includes: receiving video information of a video to be shared, playing progress information of the video to be shared, and an identification of a terminal corresponding to a friend invited by a user, which are transmitted by a user terminal; obtaining a video stream of the video to be shared according to the video information of the video to be shared and the playing progress information of the video to be shared; and transmitting the video stream of the video to be shared to the user terminal and the terminal corresponding to the friend. With the method and the device, the respective terminals are enabled to watch the same video together simultaneously and synchronously, thereby improving interactivity among the users when sharing the video.

This application is a continuation of International Application No. PCT/CN2013/089267 filed on Dec. 12, 2013, which claims priority to Chinese Patent Application No. 201310157755.8, with a title of “METHOD AND DEVICE FOR PLAYING A VIDEO”, filed on Apr. 28, 2013 with the State Intellectual Property Office of China, the entire disclosures of which are herein incorporated by reference.

### TECHNICAL FIELD

The present disclosure relates to the field of communication technology, and more particularly, to a method and device for playing a video, and a computer-readable storage medium.

### BACKGROUND

With developments of wireless Internet technology and intelligent terminal technology, people use intelligent terminals, such as mobile phones, tablet computers, etc., more and more frequently in their work and life, and the intelligent terminals have gradually replaced conventional personal computers. Watching a video via the intelligent terminals is currently one of functions of the intelligent terminals which are used frequently by people.

Conventionally, when people are watching a video, and if they want to share the video with their friends, they may copy a link address of the video in a browser and share the link address with their friends via micro-blog or instant messaging software, or share the link address of the video with their friends on a video playing application by a sharing function provided by the video playing application.

However, existing video sharing functions only support performing simple individual playing when other users open the link address of the video provided by the video sharer, which results in poor interactivity among users.

### SUMMARY

In order to solve the above problem, embodiments of the present disclosure provide a method and device for playing a video.

According to an aspect of the disclosure, there is provided a method for playing a video, including: receiving video information of a video to be shared, playing progress information of the video to be shared, and an identification of a terminal corresponding to a friend invited by a user, which are transmitted by a user terminal; obtaining a video stream of the video to be shared according to the video information of the video to be shared and the playing progress information of the video to be shared; and transmitting the video stream of the video to be shared to the user terminal and the terminal corresponding to the friend, so that the respective terminals watch the same video together simultaneously and synchronously.

According to another aspect of the disclosure, there is provided a device for playing a video, including: a first receiving module configured to receive video information of a video to be shared, playing progress information of the video to be shared, and an identification of a terminal corresponding to a friend invited by a user, which are transmitted by a user terminal; an obtaining module configured to obtain a video stream of the video to be shared, according to the video information of the video to be shared and the playing progress information of the video to be shared; and a first transmitting module configured to transmit the video stream of the video to be shared to the user terminal and the terminal corresponding to the friend, so that the respective terminals watch the same video together simultaneously and synchronously.

According to yet another aspect of the disclosure, there is provided a computer-readable storage medium having computer instructions stored thereon, the computer instructions, when executed by a computer, causing the computer to receive video information of a video to be shared, playing progress information of the video to be shared, and an identification of a terminal corresponding to a friend invited by a user, which are transmitted by a user terminal; obtain a video stream of the video to be shared according to the video information of the video to be shared and the playing progress information of the video to be shared; and transmit the video stream of the video to be shared to the user terminal and the terminal corresponding to the friend, so that the respective terminals watch the same video together simultaneously and synchronously.

According to the above aspects of the disclosure, by receiving the video information of the video to be shared, the playing progress information of the video to be shared, and the identification of the terminal corresponding to the friend invited by the user, which are transmitted by the terminal, obtaining the video stream, and transmitting the video stream to the user terminal and the terminal corresponding to the friend invited by the user, the respective terminals can watch the same video together simultaneously and synchronously, which improves interactivity among users when the video is shared.

### BRIEF DESCRIPTION OF THE DRAWINGS

In order to illustrate technical solutions of the embodiments of the present disclosure more clearly, a brief introduction to drawings required for description of the embodiments will be given below; obviously, the drawings described below are only some embodiments of the present disclosure, and those of ordinary skill in the art may obtain other drawings from these drawings without paying inventive efforts.

FIG. 1 schematically shows an environment in which the embodiments of the disclosure are applied;

FIG. 2 is a flow chart of a method for playing a video provided by one embodiment of the present disclosure;

FIG. 3 is a flow chart of a method for playing a video provided by another embodiment of the present disclosure;

FIG. 4 is a flow chart for setting a terminal's right for adjusting a video playing progress in the method for playing a video provided by the another embodiment of the present disclosure; and

FIG. 5 is a schematic structural diagram of a device for playing a video provided by yet another embodiment of the present disclosure.

### DETAILED DESCRIPTION

In order to make the object, technical solutions and advantages of the present disclosure clearer, the present disclosure will be further described in detail hereinafter in conjunction with the accompanying drawings.

Firstly, an environment in which the embodiments of the disclosure are applied is described briefly. As shown in FIG. 1, a plurality of servers 10 are connected to a plurality of terminals 20 via a network 50. The plurality of terminals 20 may include terminals used by a user who wants to share a video and by respective friends of the user, and may be intelligent terminals described above, such as smart phones, personal digital assistants (PDAs), tablet computers, or the like, or other types of terminals. The plurality of servers 10 may include a server described below which interacts with the terminals used by the user who wants to share the video and the respective friends of the user, and a source server of the video. The network 50 may be any type of wired or wireless network, such as Internet. It is to be appreciated that the numbers of the servers 10 and the terminals 20 shown in FIG. 1 are exemplary, not limitative.

Next, the respective embodiments of the present disclosure will be described.

One embodiment of the present disclosure provides a method for playing a video. The method may be executed by the server which interacts with the terminals used by the user who wants to share the video and the respective friends of the user, or may be executed by a device for playing a video described later. For convenience of description, the terminal used by the user who wants to share the video is referred to as the user terminal hereinafter.

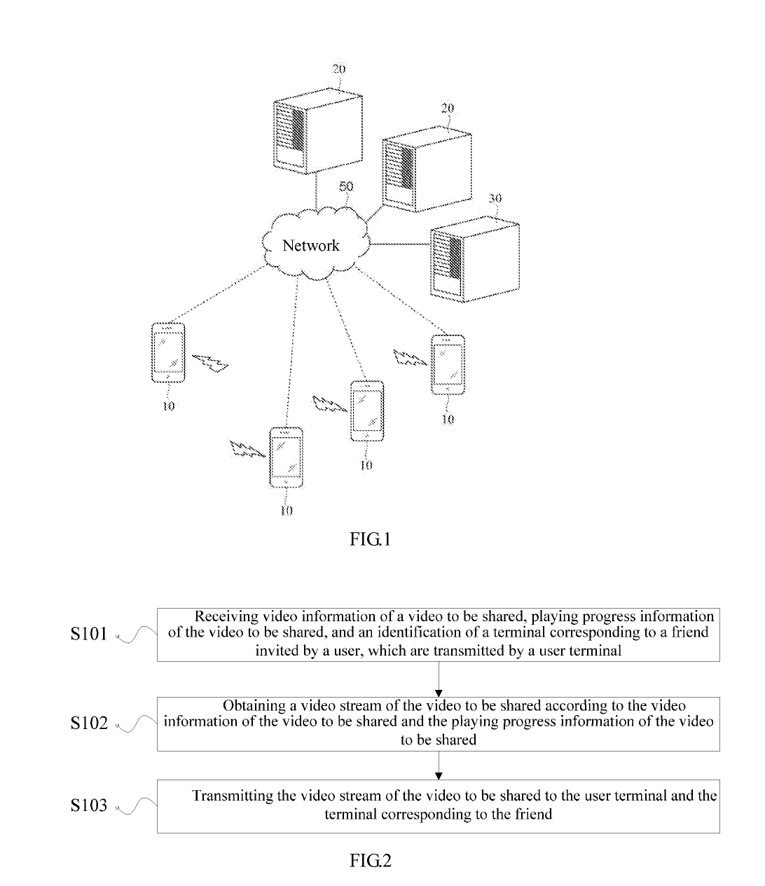

Referring to FIG. 2, the method may include the following steps.

In step S101, video information of the video to be shared, playing progress information of the video to be shared, and an identification of a terminal corresponding to a friend invited by a user, which are transmitted by the user terminal, are received. The video information may be a link address of the video to be played (i.e. the video to be shared) in a video player in a video page displayed on the user terminal, a unique identification indicating the video, or any other information indicating the video.

In step S102, a video stream of the video to be shared is obtained according to the video information of the video to be shared and the playing progress information of the video to be shared.

In step S103, the video stream of the video to be shared is transmitted to the user terminal and the terminal corresponding to the friend, so that the respective terminals watch the same video together simultaneously and synchronously.

In the embodiment of the present disclosure, by receiving the video information of the video to be shared, the playing progress information of the video to be shared and the identification of the terminal corresponding to the friend invited by the user, which are transmitted by the user terminal, obtaining the video stream, and transmitting the video stream to the user terminal and the terminal corresponding to the friend invited by the user, the respective terminals may watch the same video together simultaneously and synchronously, thereby improving interactivity among users when the video is shared.

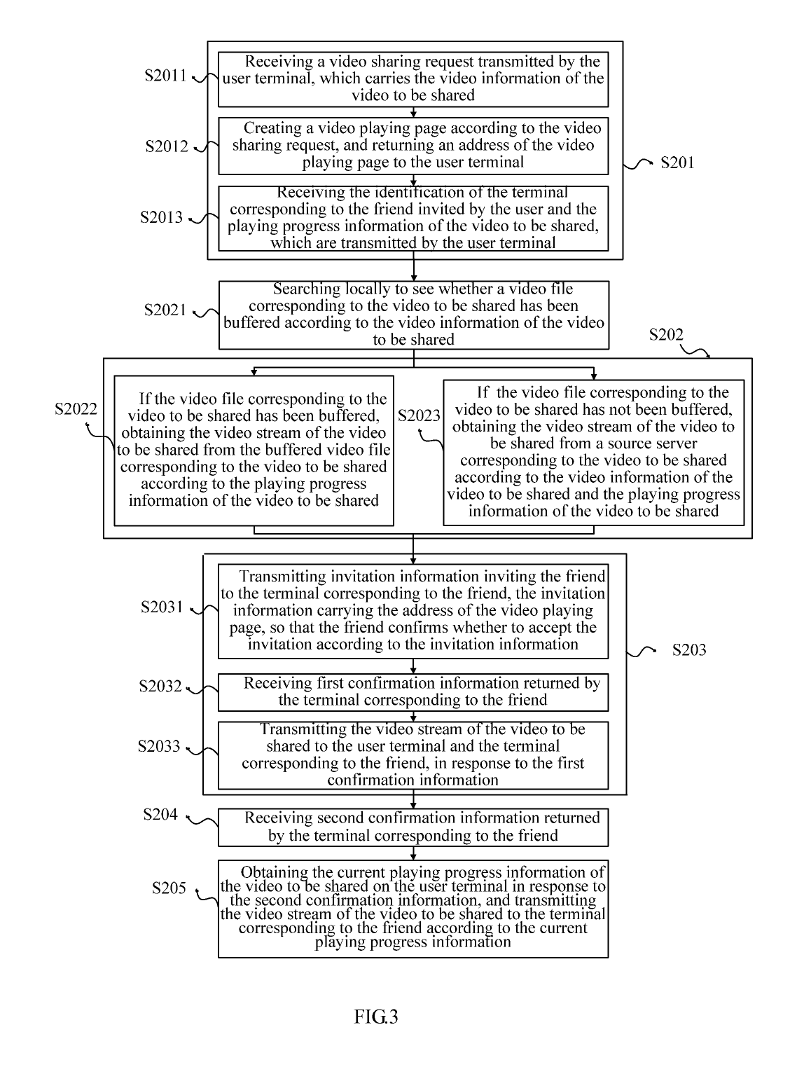

Referring to FIG. 3, another embodiment of the present disclosure provides a method for playing a video. Likewise, the method may be executed by the server connected with the user terminal or the device for playing a video.

It is to be noted that, in the embodiment of the present disclosure, a plug-in which has a video sharing function is installed in a browser of the user terminal, and with the plug-in, a sharing command sent by the user may be received, video information of a video to be shared can be obtained, and a command for creating a video playing page may be transmitted to the server.

The method for playing a video may includes the following steps.

In step S201, the video information of the video to be shared, playing progress information of the video to be shared, and an identification of a terminal corresponding to a friend invited by a user, which are transmitted by the user terminal, may be received. The user terminal is the same as that in the previous embodiment, and a description thereof is omitted.

The video information may be a link address of the video to be played (i.e. the video to be shared) in a video player in a video page displayed on the user terminal, a unique identification indicating the video, or any other information indicating the video.

Specifically, step S201 may include sub-steps S2011 to S2013.

In sub-step S2011, a video sharing request transmitted by the user terminal, which carries the video information of the video to be shared, may be received.

When the user opens a video webpage on the user terminal, the plug-in which has the video sharing function in the browser may add a sharing button into the video player in the webpage, which prompts the user that the video can be shared. If the user clicks on the sharing button, the video sharing request may be transmitted from the user terminal to the server.

In sub-step S2012, a video playing page is created according to the video sharing request, and an address of the video playing page is returned to the user terminal.

In the embodiment of the present disclosure, the server may, according to the video sharing request, generate the video playing page for shared video playing, which includes a video player. The server may push a video stream of the video to be shared to the video player, to play it for the user who watches the video in a shared manner, so that the user who opens the video playing page can watch the video in accordance with the link address of the video. The page further includes a list of friends which can be invited by the user, so that the user can invite the friends according to the list. This list may be obtained by searching in the server according to the user's identification, where the user's identification can be transmitted to the server via the video sharing request.

After the video playing page is generated, the address (i.e. link address) of the page may be returned to the user terminal. After the user terminal receives the link address, the browser on the user terminal may open a new page according to the link address to load a page corresponding to the link address. After the page is opened, it will wait the user to click on it to play the video. At this time, the user can, according to his/her personal demand, select a friend(s) to share the video.

Further, the video playing page may also have an interactive function, such as chatting among respective users who are watching the video on the page, and a function which can be realized in a chat room, such as gift giving or the like.

In sub-step S2013, the identification of the terminal corresponding to the friend invited by the user and the playing progress information of the video to be shared, which are transmitted by the user terminal may be received.

After the user opens the video playing page, the user may select a friend to be invited on the page. At this time, a default playing progress of the video to be shared is starting playing at the beginning of the video stream of the video. Therefore, the playing progress information of the video may be a start time 00:00 of the video.

Next, in step S202, a video stream of the video to be shared may be obtained according to the video information of the video to be shared and the playing progress information of the video to be shared.

The step of obtaining the video stream of the video to be shared may include sub-steps S2021 to S2023.

In sub-step S2021, a search may be performed locally (.e.g. in a local buffer of the server) according to the video information of the video to be shared, to see whether a video file corresponding to the video to be shared has been buffered.

By searching in the local buffer of the server to see whether the video file corresponding to the video to be shared has been buffered (e.g. whether a user once shared the video), a network traffic and time taken for obtaining the video stream can be saved.

If the video file corresponding to the video to be shared has been buffered, the video stream of the video to be shared may be obtained from the buffered video file corresponding to the video to be shared according to the playing progress information of the video to be shared in sub-step S2022.

If the video file corresponding to the video to be shared has not been buffered, the video stream of the video to be shared may be obtained from a source server corresponding to the video to be shared according to the video information of the video to be shared and the playing progress information of the video to be shared in sub-step S2023.

Next, in step S203, the video stream of the video to be shared is transmitted to the user terminal and the terminal corresponding to the friend, so that the respective terminals can watch the same video together simultaneously and synchronously.

Specifically, the step S203 may include sub-steps S2031 to S2033.

In sub-steps S2031, invitation information inviting the friend may be transmitted to the terminal corresponding to the friend, the invitation information carrying the address (i.e. the link address) of the video playing page so that the friend may confirm whether to accept the invitation according to the invitation information.

After receiving the invitation information, the terminal corresponding to the friend may open the link address if the invitation is accepted. Specifically, the browser of the terminal may open a new page to load the video playing page, and meanwhile returns confirmation information (hereinafter referred to as first confirmation information for convenience of description) to the server. The plug-in which has the video sharing function may be installed in browsers of other terminals than the user terminal. If the invitation is not accepted, the invitation information may be ignored.

In sub-step S2032, the first confirmation information returned by the terminal corresponding to the friend may be received.

After the friend accepts the invitation, the server may further transmit a user identification corresponding to the friend who accepts the invitation to other terminals which have accepted the invitation, so that the respective terminals update in the video playing page a list of users (friends) who have joined, i.e. a list of all friends who have accepted the invitation.

In sub-step S2033, the video stream of the video to be shared may be transmitted to the user terminal and the terminal corresponding to the friend in response to the first confirmation information.

In step S204, confirmation information (hereinafter referred to as second confirmation information for convenience of description) returned by the terminal corresponding to the friend may be received.

At this time, the received second confirmation information returned by the terminal corresponding to the friend may be used as trigger information used to trigger sending the video stream corresponding to a current playing progress of the video to the terminal which returns the second confirmation information. Specifically, after the user who uses the user terminal controls to play the video, and when the second confirmation information is received, the playing progress of the video is no longer the initial start state, therefore, it is necessary to send the corresponding video stream to the terminal which returns the second confirmation information after the playing of the video is started (e.g. the terminal corresponding to the friend), according to the current playing progress of the video.

In step S205, the current playing progress information of the video to be shared on the user terminal may be obtained in response to the second confirmation information, and the video stream of the video to be shared may be transmitted to the terminal corresponding to the friend according to the current playing progress information of the video to be shared on the user terminal.

After receiving the second confirmation information, the server may, according to the playing progress information of the video stream of the video currently transmitted to the respective terminals, transmit the video stream to the terminal which returns the second confirmation information. When the terminal corresponding to the friend receives the video stream and plays it, the played video stream is synchronized with the video watched by the user who is an initiator of the video sharing request, and the playing is not necessarily performed from the start time of the video stream.

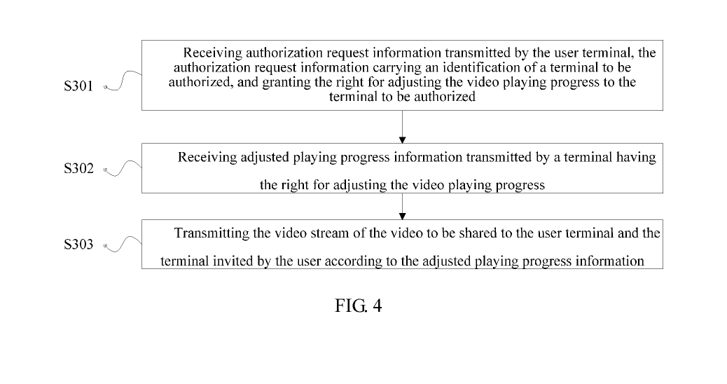

In the embodiment of the prevent disclosure, rights of the respective terminals may further be set, so that a user of a terminal having the right can adjust the video playing progress. A method for setting the rights is shown in FIG. 4.

In step S301, authorization request information, which carries an identification of a terminal to be authorized, transmitted by the user terminal may be received, and the right for adjusting the video playing progress mat be granted to the terminal to be authorized in response to the authorization request information.

Initially, the initiator of the video sharing request (e.g. the user terminal) may have a highest right by default, and thus may perform adjustment of the video playing progress, such as pause and stop the playing, in the video playing webpage. The initiator of the video sharing request may also select other users in the webpage and authorize the users, so that the users obtain the right for adjusting the video playing progress.

In step S302, adjusted playing progress information transmitted by a terminal having the right for adjusting the video playing progress may be received.

In step S303, the video stream of the video to be shared may be transmitted to the respective terminals including the user terminal and the terminal invited by the user according to the adjusted playing progress information.

By receiving the video information of the video to be shared, the playing progress information of the video to be shared and the identification of the terminal corresponding to the friend invited by the user, which are transmitted by the user terminal, obtaining the video stream, and transmitting the video stream to the user terminal and the terminal corresponding to the friend invited, the embodiment of the present disclosure enables the respective terminals to watch the same video together simultaneously and synchronously, thereby improving the interactivity among the users when sharing the video.

Yet another embodiment of the present disclosure provides a device for playing a video. The device may execute the method provided by the previous embodiment. Because details of operations performed by the device are the same as those in the previous embodiment, only a brief description of the device is given, and descriptions of the same details are omitted here. Additionally, the device may be included in the server shown in FIG. 1.

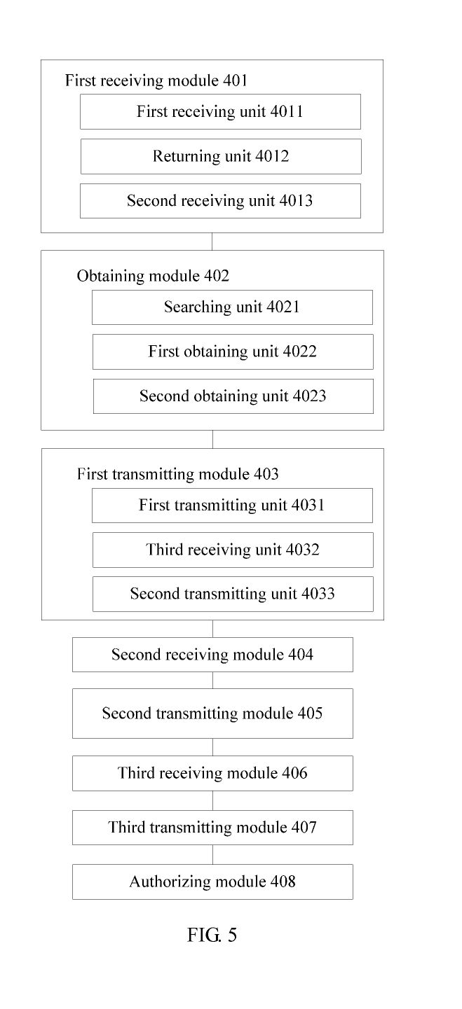

Referring to FIG. 5, the device includes a first receiving module 401, an obtaining module 402, and a first transmitting module 403.

The first receiving module 401 is configured to receive video information of the video to be shared, playing progress information of the video to be shared, and an identification of a terminal corresponding to a friend invited by a user, which are transmitted by a user terminal.

The obtaining module 402 is configured to obtain a video stream of the video to be shared, according to the video information of the video to be shared and the playing progress information of the video to be shared.

The first transmitting module 403 is configured to transmit the video stream of the video to be shared to the user terminal and the terminal corresponding to the friend, so that the respective terminals can watch the same video together simultaneously and synchronously.

In an implementation, the first receiving module 401 may include a first receiving unit 4011, a returning unit 4012, and a second receiving unit 4013.

The first receiving unit 4011 is configured to receive a video sharing request transmitted by the user terminal, the video sharing request carrying the video information of the video to be shared.

The returning unit 4012 is configured to create a video playing page according to the video sharing request, and return an address of the video playing page to the user terminal.

The second receiving unit 4013 is configured to receive the identification of the terminal corresponding to the friend invited by the user and the playing progress information of the video to be shared, which are transmitted by the user terminal.

In an implementation, the first transmitting module 403 may include a first transmitting unit 4031, a third receiving unit 4032, and a second transmitting unit 4033.

The first transmitting unit 4031 is configured to transmit invitation information for inviting the friend to the terminal corresponding to the friend, the invitation information carrying the address of the video playing page, so that the friend may confirm whether to accept the invitation according to the invitation information.

The third receiving unit 4032 is configured to receive first confirmation information returned by the terminal corresponding to the friend.

The second transmitting unit 4033 is configured to transmit the video stream of the video to be shared to the user terminal and the terminal corresponding to the friend in response to first confirmation information.

In an implementation, the device may further include a second receiving module 404 and a second transmitting module 405.

The second receiving module 404 is configured to receive second confirmation information returned by the terminal corresponding to the friend.

The second transmitting module 405 is configured to obtain the current playing progress information of the video to be shared on the user terminal in response to the second confirmation information, and transmit the video stream of the video to be shared to the terminal corresponding to the friend according to the current playing progress information of the video to be shared on the user terminal.

In an implementation, the obtaining module 402 may include a searching unit 4021, a first obtaining unit 4022, and a second obtaining unit 4023.

The searching unit 4021 is configured to search locally to see whether a video file corresponding to the video to be shared has been buffered according to the video information of the video to be shared.

The first obtaining unit 4022 is configured to obtain the video stream of the video to be shared from the buffered video file corresponding to the video to be shared, according to the playing progress information of the video to be shared, if the video file corresponding to the video to be shared has been buffered.

The second obtaining unit 4023 is configured to obtain the video stream of the video to be shared from a source server corresponding to the video to be shared, according to the video information of the video to be shared and the playing progress information of the video to be shared, if the video file corresponding to the video to be shared has not been buffered.

In am implementation, the device may further include a third receiving module 406 and a third transmitting module 407.

The third receiving module 406 is configured to receive adjusted playing progress information transmitted by a terminal having a right for adjusting the video playing progress.

The third transmitting module 407 is configured to transmit the video stream of the video to be shared to the user terminal and the terminal invited by the user, according to the adjusted playing progress information.

In an implementation, the device may further include an authorizing module 408 configured to receive authorization request information transmitted by the user terminal, which carries an identification of a terminal to be authorized, and grant the right for adjusting the video playing progress to the terminal to be authorized in response to the authorization request information.

By receiving the video information of the video to be shared, the playing progress information of the video to be shared and the identification of the terminal corresponding to the friend invited by the user, which are transmitted by the user terminal, obtaining the video stream, and transmitting the video stream to the user terminal and the terminal corresponding to the friend invited, the embodiment of the present disclosure enables the respective terminals to watch the same video together simultaneously and synchronously, thereby improving the interactivity among the users when sharing the video.

The sequence numbers of the embodiments of present disclosure are only for the purpose of description, and do not represent whether the embodiments are good or not.

It is to be understood by those skilled in the art that all or a part of steps for implementing the above embodiments can be completed by hardware or by instructing related hardware by a program. The hardware may, for example, be a general purpose computing device, such as a computer, which includes a processor element(s), such as a central processing unit (CPU), and a storage elements(s), such a random access memory (RAM), a read-only memory (ROM), and the like, and the program can be stored in a computer-readable storage medium, such as a ROM, a magnetic disk, an optical disk, or the like. For example, computer instructions may be stored on the computer-readable storage medium, and the computer instructions, when executed by a computer, causes the computer to receive video information of a video to be shared, playing progress information of the video to be shared, and an identification of a terminal corresponding to a friend invited by a user, which are transmitted by a user terminal, obtain a video stream of the video to be shared according to the video information of the video to be shared and the playing progress information of the video to be shared, and transmit the video stream of the video to be shared to the user terminal and the terminal corresponding to the friend, so that the respective terminals watch the same video together simultaneously and synchronously.

The above embodiments are only preferred embodiments of the present disclosure, and are not intended to limit the disclosure. Any modifications, equivalent replacements, improvement and the like are included in the protection scope of the disclosure without departing from the spirit and principle of the disclosure.

What is claimed is:

1. A method for playing a video, comprising:
receiving video information of a video to be shared, playing progress information of the video to be shared, and an identification of a terminal corresponding to a friend invited by a user, which are transmitted by a user terminal;
obtaining a video stream of the video to be shared according to the video information of the video to be shared and the playing progress information of the video to be shared; and
transmitting the video stream of the video to be shared to the user terminal and the terminal corresponding to the friend, so that the respective terminals watch the same video together simultaneously and synchronously.

2. The method of claim 1, wherein the receiving video information of a video to be shared, playing progress information of the video to be shared, and an identification of a terminal corresponding to a friend invited by a user, which are transmitted by a user terminal comprises:
receiving a video sharing request transmitted by the user terminal, the video sharing request carrying the video information of the video to be shared;
creating a video playing page according to the video sharing request, and returning an address of the video playing page to the user terminal; and
receiving the identification of the terminal corresponding to the friend invited by the user and the playing progress information of the video to be shared, which are transmitted by the user terminal.

3. The method of claim 2, wherein the transmitting the video stream of the video to be shared to the user terminal and the terminal corresponding to the friend comprises:
transmitting invitation information for inviting the friend to the terminal corresponding to the friend, the invitation information carrying the address of the video playing page, so that the friend confirms whether to accept the invitation according to the invitation information;
receiving first confirmation information returned by the terminal corresponding to the friend; and
transmitting the video stream of the video to be shared to the user terminal and the terminal corresponding to the friend in response to the first confirmation information.

4. The method of claim 3, wherein after sending the video stream of the video to be shared to the user terminal and the terminal corresponding to the friend, the method further comprises:
receiving second confirmation information returned by the terminal corresponding to the friend; and
obtaining current playing progress information of the video to be shared on the user terminal, and transmitting the video stream of the video to be shared to the terminal corresponding to the friend according to the current playing progress information of the video to be shared on the user terminal.

5. The method of claim 1, wherein the obtaining a video stream of the video to be shared according to the video information of the video to be shared and the playing progress information of the video to be shared comprises:
searching locally to see whether a video file corresponding to the video to be shared has been buffered according to the video information of the video to be shared;
if the file corresponding to the video to be shared has been buffered, obtaining the video stream of the video to be shared from the buffered video file corresponding to the video to be shared, according to the playing progress information of the video to be shared; and
if the file corresponding to the video to be shared has not been buffered, obtaining the video stream of the video to be shared from a source server corresponding to the video to be shared, according to the video information of the video to be shared and the playing progress information of the video to be shared.

6. The method of claim 1, wherein after transmitting the video stream of the video to be shared to the user terminal and the terminal corresponding to the friend, the method further comprises:
receiving adjusted playing progress information transmitted by a terminal having a right for adjusting the video playing progress; and
transmitting the video stream of the video to be shared to the user terminal and the terminal invited by the user according to the adjusted playing progress information.

7. The method of claim 1, wherein after transmitting the video stream of the video to be shared to the user terminal and the terminal corresponding to the friend, the method further comprises:
receiving authorization request information, which carries an identification of a terminal to be authorized, transmitted by the user terminal, and granting the right for adjusting the video playing progress to the terminal to be authorized in response to the authorization request information.

8. A device for playing a video, comprising:
a first receiving module configured to receive video information of a video to be shared, playing progress information of the video to be shared, and an identification of a terminal corresponding to a friend invited by a user, which are transmitted by a user terminal;
an obtaining module configured to obtain a video stream of the video to be shared, according to the video information of the video to be shared and the playing progress information of the video to be shared; and
a first transmitting module configured to transmit the video stream of the video to be shared to the user terminal and the terminal corresponding to the friend, so that the respective terminals watch the same video together simultaneously and synchronously.

9. The device of claim 8, wherein the first receiving module comprises:
a first receiving unit configured to receive a video sharing request transmitted by the user terminal, the video sharing request carrying the video information of the video to be shared;
a returning unit configured to create a video playing page according to the video sharing request, and returning an address of the video playing page to the user terminal; and
a second receiving unit configured to receive the identification of the terminal corresponding to the friend invited by the user and the playing progress information of the video to be shared, which are transmitted by the user terminal.

10. The device of claim 9, wherein the first transmitting module comprises:
a first transmitting unit configured to transmit invitation information for inviting the friend to the terminal corresponding to the friend, the invitation information carrying the address of the video playing page, so that the friend confirms whether to accept the invitation according to the invitation information;
a third receiving unit configured to receive first confirmation information returned by the terminal corresponding to the friend; and
a second transmitting unit configured to transmit the video stream of the video to be shared to the user terminal and the terminal corresponding to the friend in response to the first confirmation information.

11. The device of claim 10, further comprising:
a second receiving module configured to receive second confirmation information returned by the terminal corresponding to the friend; and
a second transmitting module configured to obtain current playing progress information of the video to be shared on the user terminal in response to the second conformation information, and transmit the video stream of the video to be shared to the terminal corresponding to the friend according to the current playing progress information of the video to be shared on the user terminal.

12. The device of claim 8, wherein the obtaining module comprises:
a searching unit configured to search locally to see whether a video file corresponding to the video to be shared has been buffered according to the video information of the video to be shared;
a first obtaining unit configured to obtain the video stream of the video to be shared from the buffered video file corresponding to the video to be shared, according to the playing progress information of the video to be shared, if the file corresponding to the video to be shared has been buffered;
a second obtaining unit configured to obtain the video stream of the video to be shared from a source server corresponding to the video to be shared, according to the video information of the video to be shared and the playing progress information of the video to be shared, if the file corresponding to the video to be shared has not been buffered.

13. The device of claim 8, further comprising:
a third receiving module configured to receive adjusted playing progress information transmitted by a terminal having a right for adjusting the video playing progress;
a third transmitting module configured to transmit the video stream of the video to be shared to the user terminal and the terminal invited by the user according to the adjusted playing progress information.

14. The device of claim 8, further comprising:
an authorizing module configured to receive authorization request information, which carries an identification of a terminal to be authorized, transmitted by the user terminal, and granting the right for adjusting the video playing progress to the terminal to be authorized in response to the authorization request information.

15. A computer-readable storage medium having computer instructions stored thereon, the computer instructions, when executed by a computer, causing the computer to:
receive video information of a video to be shared, playing progress information of the video to be shared, and an identification of a terminal corresponding to a friend invited by a user, which are transmitted by a user terminal;
obtain a video stream of the video to be shared according to the video information of the video to be shared and the playing progress information of the video to be shared; and
transmit the video stream of the video to be shared to the user terminal and the terminal corresponding to the friend, so that the respective terminals watch the same video together simultaneously and synchronously.
